(19) United States
(12) Patent Application Publication
(10) Pub. No.: US 2008/0298172 A1
(43) Pub. Date: Dec. 4, 2008

(54) BLENDER APPARATUS WITH ALTERNATE BLADE MECHANISMS

(76) Inventor: CHARLES Z. KRASZNAI, Bridgeport, CT (US)

Correspondence Address: Lawrence Cruz;Conair Corporation, One Cummings Point Road, STAMFORD, CT, 06902, US

(21) Appl. No.: 12/131,466

(22) Filed: Jun. 2, 2008

Related U.S. Application Data
(60) Provisional application No. 60/932,688, filed on Jun. 1, 2007.

(51) Int. Cl. B01F 7/00

(52) U.S. Cl. 366/314

(57) ABSTRACT

A blender apparatus (10) includes a blender jar (14) having a base (16) and a container (18) for receiving food products; and a blade mechanism at least partially disposed within the blender jar (14). The blade mechanism includes a drive shaft (32) defining a shaft axis and being engageable with a drive mechanism for rotating the drive shaft (32) and first and second cutting blades (36, 38) mounted to the drive shaft (32). The first cutting blade (36) generally extends along the shaft axis and has at least one cutting edge (40) while the second cutting blade (38) traverses the shaft axis and also has at least one cutting edge (44). The first cutting blade (36) may have opposed cutting edges (40). The opposed cutting edges (40) may be dimensioned to extend to an apex (42) of the first cutting blade (36). The apex (42) may be generally sharp. The second cutting blade (38) may include a pair of opposed lobes (46) with each lobe (46) defining an arcuate profile and having a cutting edge (44). The cutting edges (44) of the second cutting blade (38) may be arranged in opposed relation.

### BACKGROUND

1. Technical Field

The present disclosure generally relates to a food blender apparatus and, in particular, relates to a food blender having a blade and associated clutch mechanism adapted for pulverizing food products and crushing ice.

2. Description of Related Art

Blenders are employed to chop, mix, and blend varying food products or liquids. Electric blenders include a motor unit for rotating a shaft and a blade mounted to the shaft. Some conventional blenders incorporate a single blade for chopping food. However, these blade arrangements are not well adapted for pulverizing food products and/or chopping ice into fine particles. Moreover, use of the blender for pulverizing ice crushing was secondary, with the crushing quality not being a significant design factor.

### SUMMARY

Accordingly, the present disclosure is directed to further improvements in blender apparatuses. The blender apparatus includes a blender jar having a base and a container for receiving food products; and a blade mechanism at least partially disposed within the blender jar. The blade mechanism includes a drive shaft defining a shaft axis and being engageable with a drive mechanism for rotating the drive shaft and first and second cutting blades mounted to the drive shaft. The first cutting blade generally extends along the shaft axis and has at least one cutting edge while the second cutting blade traverses the shaft axis and also has at least one cutting edge. The first cutting blade may have opposed cutting edges. The opposed cutting edges may be dimensioned to extend to an apex of the first cutting blade. The apex may be generally sharp. The second cutting blade may include a pair of opposed lobes with each lobe defining an arcuate profile and having a cutting edge. The cutting edges of the second cutting blade may be arranged in opposed relation.

In another embodiment, the blender apparatus includes a blender jar having a base and a container for receiving food products and a blade mechanism at least partially disposed within the blender jar. The blade mechanism includes a drive shaft defining a shaft axis and being engageable with a drive mechanism for rotating the drive shaft and a cutting blade mounted to the drive shaft. The cutting blade has a pair of blade elements generally extending along the shaft axis. Each blade element has a recess therein defining a pair of vertices adjacent the recess. The vertices are dimensioned to chop the food products.

In yet another embodiment, the blender apparatus includes a blender jar having a base and a container for receiving food products and a blade mechanism at least partially disposed within the blender jar. The blade mechanism includes a drive shaft defining a shaft axis and being engageable with a drive mechanism for rotating the drive shaft and a cutting blade mounted to the drive shaft. The cutting blade has a first set of diametrically opposed lobes defining opposed cutting edges and a second pair of diametrically opposed lobes defining opposed cutting edges. The lobes of the second set are arranged in oblique relation with respect to the shaft axis. The lobes of the first set may be arranged in general transverse relation to the shaft axis.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiment(s) given below, serve to explain the principles of the disclosure, wherein

FIG. 1 is a perspective view of a blender apparatus in accordance with the principles of the present disclosure;

FIGS. 2-4 are side plan views of the blender apparatus;

FIGS. 5-6 are top plan views of the blender apparatus;

FIG. 7 is a perspective view of the blender apparatus;

FIG. 8 is a view of a blade of the blender apparatus;

FIGS. 9A-9C are top plan, side plan and axial views of the blade of FIG. 9;

FIGS. 10-11 are perspective views of an alternate embodiment of a blade of the blender apparatus; and

FIGS. 12-13 are perspective views of another alternate embodiment of a blade of the blender apparatus;

### DETAILED DESCRIPTION

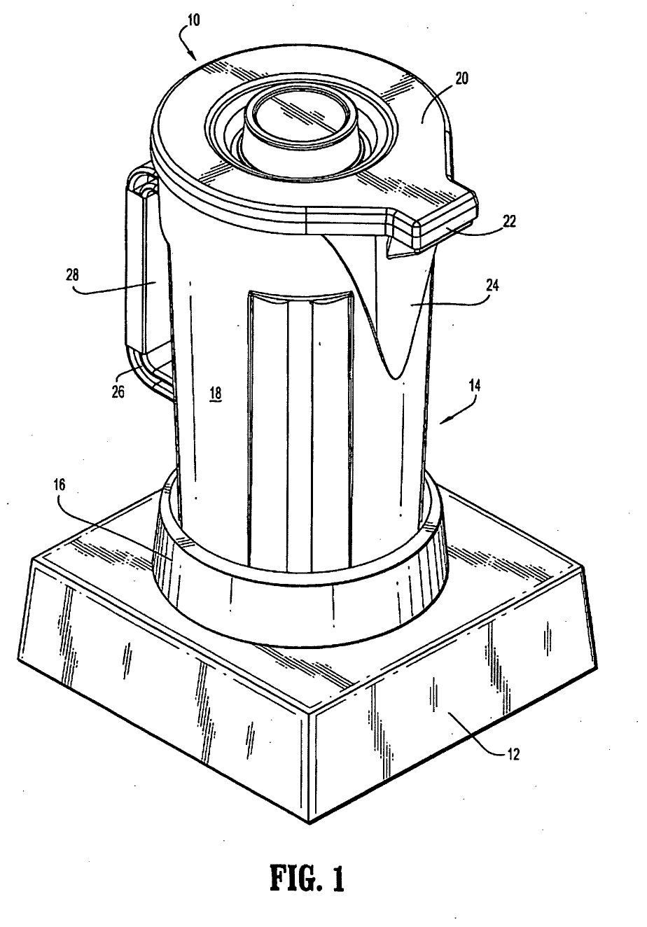

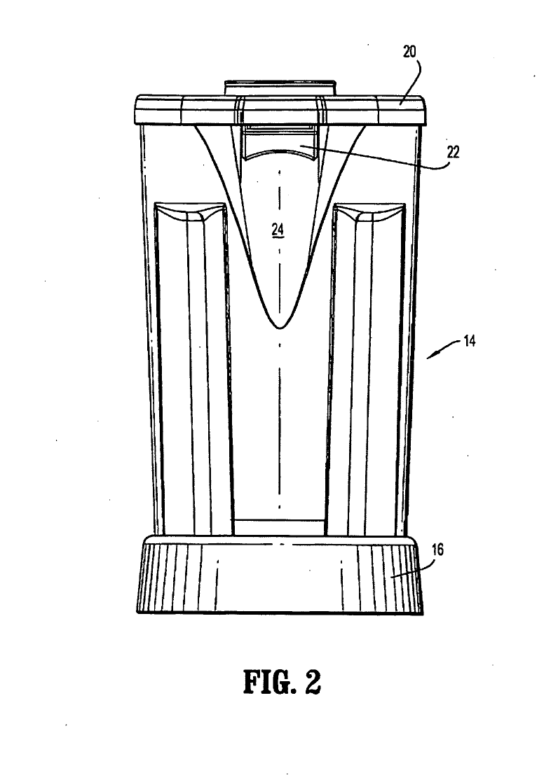

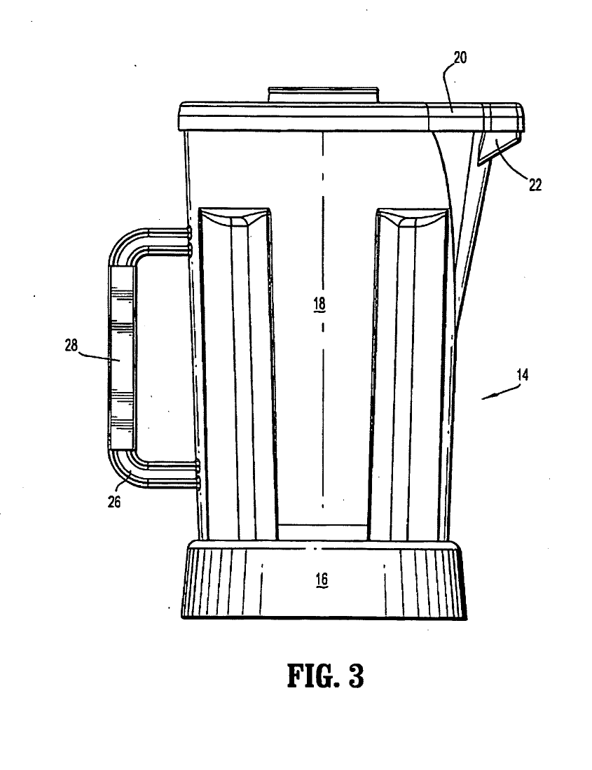

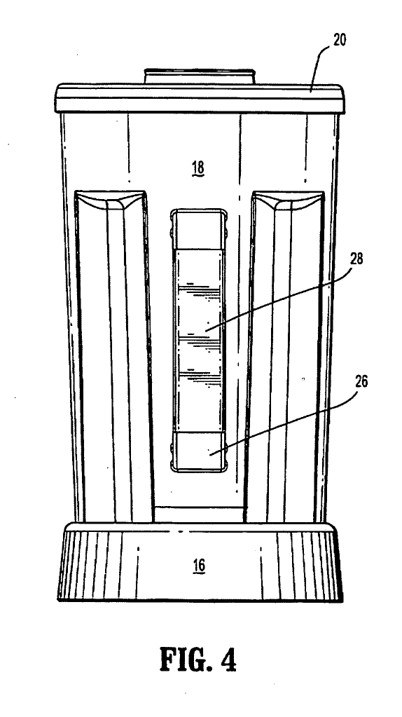

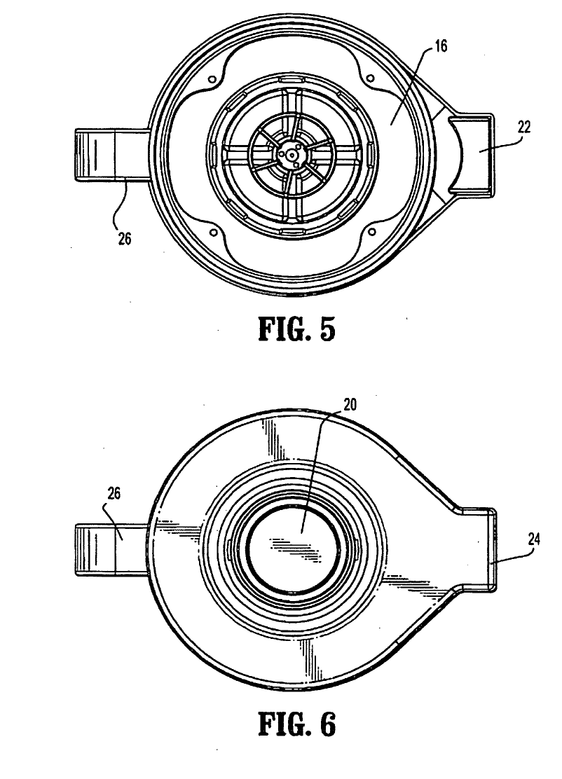

Referring now to the drawings wherein like references identical or similar elements throughout the several views, FIGS. 1-9 illustrate an embodiment(s) of the blender apparatus in accordance with the principles of the present disclosure. Blender apparatus 10 is preferably a portable unit adapted for positioning on a support surface such as a table, countertop or the like. Blender apparatus 10 includes motor unit 12 (shown schematically in FIG. 1) and blender jar 14 releasably mounted to the motor unit 12. Motor unit 12 incorporates a variable speed motor which is controlled through various dials, buttons etc. mounted to the surface of the motor unit 12. One suitable blender arrangement is disclosed in commonly assigned U.S. Pat. No. 5,487,511 to Sansone et al., the entire contents of which are incorporated herein by reference.

Blender jar 14 incorporates base 16, container 18 extending from the base 16 and blender lid 20 which encloses the interior of the container 18. Base 16 incorporates the cutting mechanism which will be discussed hereinbelow. Blender lid 20 may have pouring spout 22 to facilitate dispensing of the materials within container 18. Spout 22 may be directed downwardly as shown and is adjacent recess 24 within container 18. Blender jar 14 further includes handle 26 depending from container 18 and being dimensioned for engagement by the user. Handle 26 may incorporate an elastomeric grip 28 for user comfort. Grip 28 may be over molded onto handle 26. Grip 28 may comprise a suitable elastomer, foam or gel material.

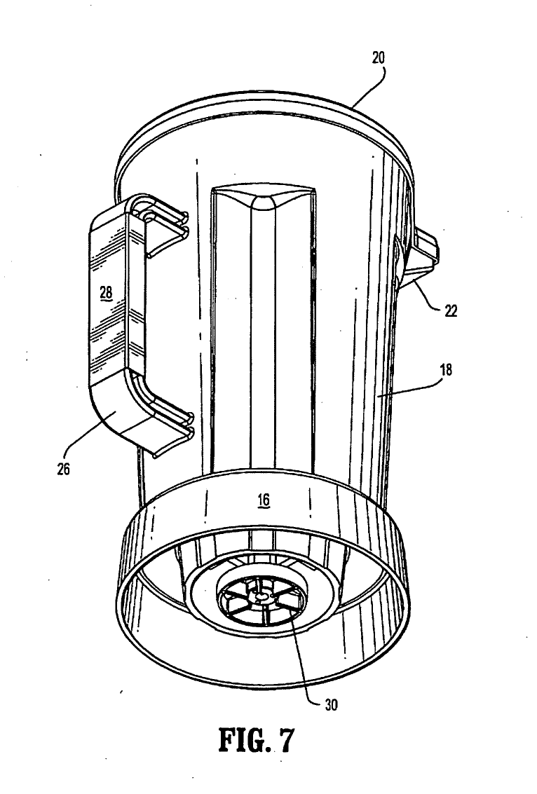

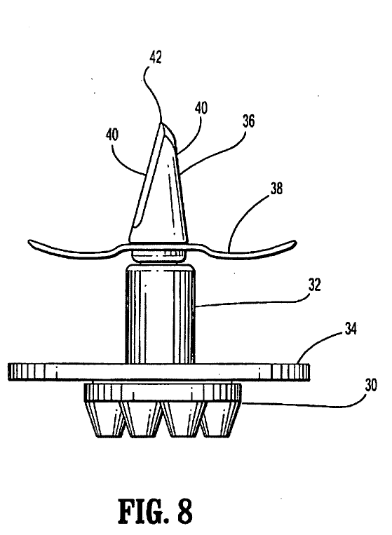

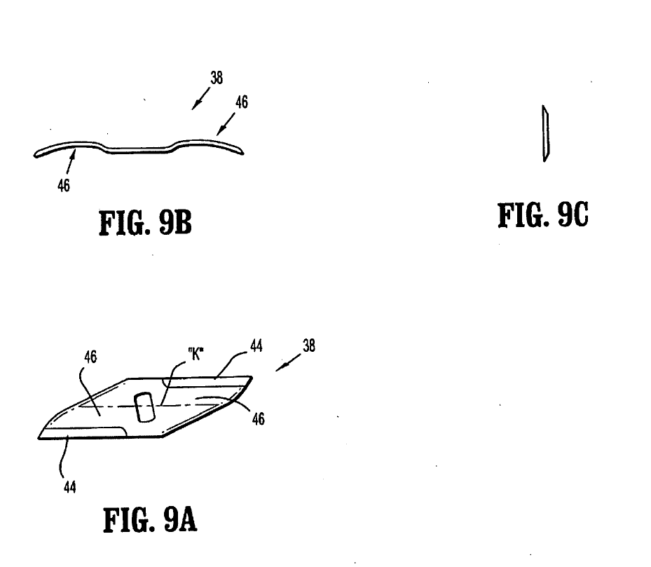

With reference to FIGS. 8 and 9A-9C, in conjunction with FIG. 7, the rotatable cutting mechanism of blender apparatus 10 will be discussed. The cutting mechanism may include clutch 30, drive shaft 32 depending from the clutch 30 and at least one blade mounted to the drive shaft. Clutch 30 is adapted to engage a clutch of motor unit 12 to impart rotational movement to the cutting mechanism. Drive shaft 32 extends through a lower opening of blender jar 14 and incorporates a disc shaped element 34 for mounting relative to the lower interior surface of the blender jar 14.

The cutting blades of blender apparatus 10 are adapted for pulverizing or chopping food products and may also chop ice into fine particles (e.g., slush). The cutting blades may have various designs. In the embodiment of FIGS. 8 and 9A-9C, a two blade design, namely, first blade 36 and second blade 38, is provided. First blade 36 is vertically oriented and incorporates a base which may be mounted to the vertical hub of drive shaft 32. First blade 36 may be threadably secured to the vertical hub of drive shaft 32 as is known in the art. First blade 36 includes opposed cutting edges 40 which extend to vertical apex 42 as shown. Apex 42 may be rounded or sharp.

The specific details of second blade 38 may be ascertained by reference to the prints of the second blade 38 depicted in FIGS. 9A-9C. Second blade 38 also incorporates opposed cutting edges 44. Specifically, second blade 38 includes a pair of lobes 46 symmetrically arranged about axis “K”. Each lobe 46 defines an arcuate vertical contour which displaces cutting edges 44 in position to chop the food material. (See also FIG. 8)

The combination of first and second blades 36, 38 provides benefits with respect to chopping and/or pulverizing food, and chopping ice to fine particles if desired. For example, first blade 36 initially chops the food particles, e.g., ice, as it enters blender jar 14. The cutting and chopping action is continued by second blade 38. It is envisioned that first blade 36 may be removed and second blade 38 may operate in an individual manner.

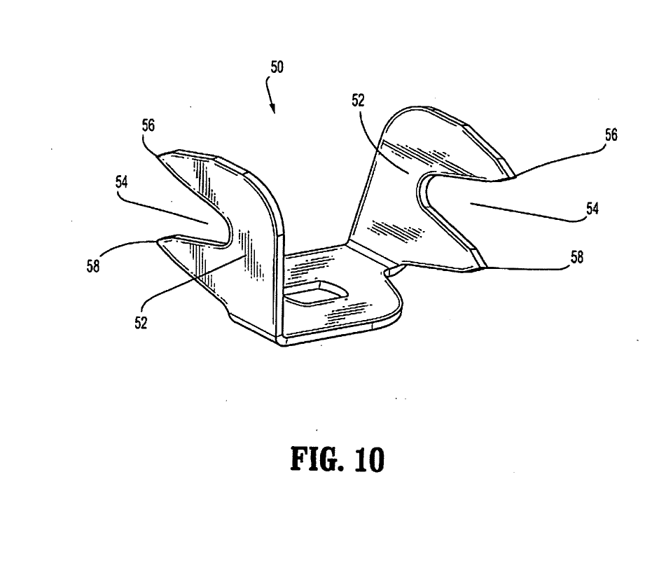

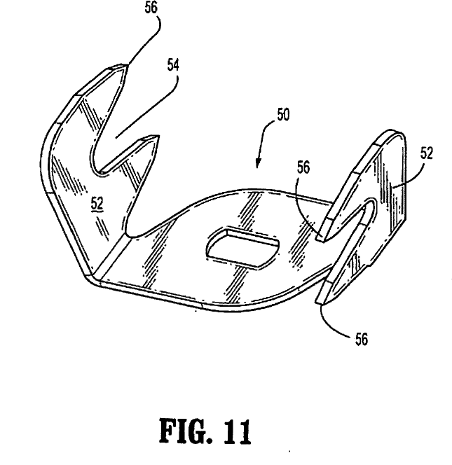

FIGS. 10-11 illustrate an alternate embodiment of a blade for cutting mechanism. Blade 50 may be used in combination with the first blade 36 of the embodiment of FIGS. 1-9C, or may be used individually and secured to drive shaft 32 with a nut, e.g., an acorn nut. Blade 50 is particularly adapted for pulverizing ice and incorporates a pair of vertical members 52 each defining a triangular shaped recess 54 therein. Vertical members 52 further define upper and lower vertices 56, 58 adjacent vertical recess 54. Vertices 56, 58 may be relatively sharp to break the ice during activation of the blender. Thus, with this arrangement, the ice may be chipped at two vertical locations, i.e., adjacent upper vertices 56 and adjacent lower vertices 58.

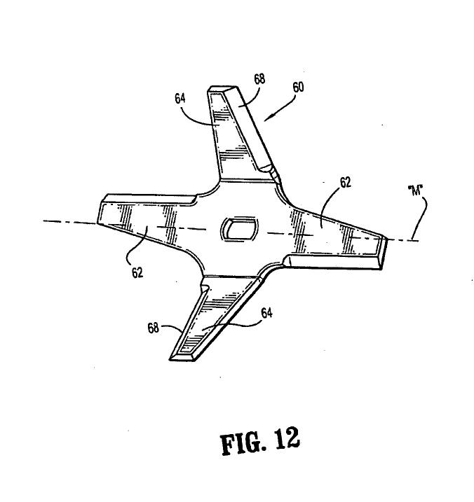

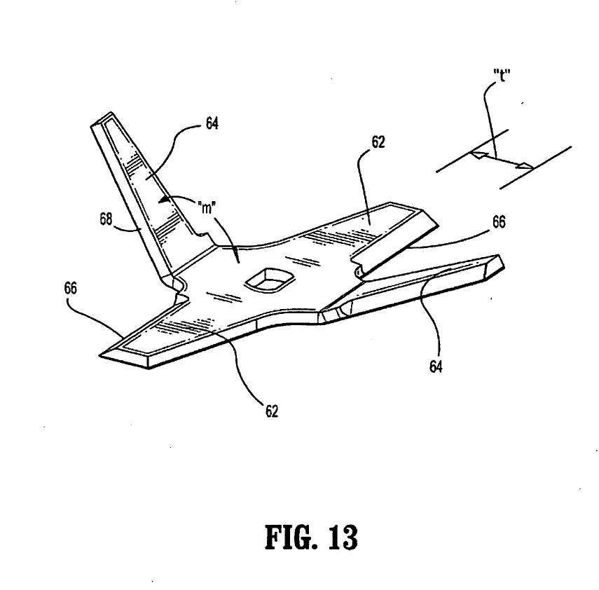

FIGS. 12-13 illustrate an alternate embodiment of a blade for cutting mechanism. Blade 60 may be used in combination with first blade 36 of the embodiment of FIGS. 1-9C, or may be used individually as hereinabove discussed. Blade 60 is a four lobe design having a first set of lobes 62 symmetrically arranged about axis “m” and a second set of lobes 64. The first set of lobes is generally horizontal with respect to the horizontal plane “t” (FIG. 13) and incorporates opposed cutting edges 66. The second set of lobes 64 is inclined relative to the horizontal plane “t” at an angle “m” ranging from about 5° to about 85°, and also defines opposed cutting edges 68. This arrangement provides advantages with respect to blending food material which may be relatively coarse. In one mode, the second lobe of blades 64 initially contacts the food material as it enters blender jar 14 after which the food material falls to the first set of lobes 62 where chopping is continued, thus, also providing a chopping action at two vertical locations within blender jar 14.

The blender apparatus 10 of the present invention is capable of chopping and/or pulverizing a large volume of ice, e.g., a whole tray of ice, with relative ease. Moreover, the blade designs are capable of rapidly and efficiently chipping ice material.

While the invention has been particularly shown, and described with reference to the preferred embodiments, it will be understood by those skilled in the art that various modifications and changes in form and detail may be made therein without departing from the scope and spirit of the invention. Accordingly, modifications such as those suggested above, but not limited thereto, are to be considered within the scope of the invention.

What is claimed is:

1. A blender apparatus, which comprises:
a blender jar including a base and a container for receiving food products; and
a blade mechanism at least partially disposed within the blender jar, the blade mechanism including:
a drive shaft defining a shaft axis and being engageable with a drive mechanism for rotating the drive shaft; and
first and second cutting blades mounted to the drive shaft, the first cutting blade generally extending along the shaft axis and having at least one cutting edge, the second blade traversing the shaft axis and having at least one cutting edge.

2. The blender apparatus according to claim 1 wherein the first cutting blade has opposed cutting edges.

3. The blender apparatus according to claim 2 wherein the opposed cutting edges are dimensioned to extend to an apex of the first cutting blade.

4. The blender apparatus according to claim 3 wherein the apex is generally sharp.

5. The blender apparatus according to claim 1 wherein the second cutting blade includes a pair of opposed lobes, each lobe defining an arcuate and having a cutting edge.

6. The blender apparatus according to claim 5 wherein the cutting edges of the second cutting blade are arranged in opposed relation.

7. A blender apparatus, which comprises:
a blender jar including a base and a container for receiving food products; and
a blade mechanism at least partially disposed within the blender jar, the blade mechanism including:
a drive shaft defining a shaft axis and being engageable with a drive mechanism for rotating the drive shaft; and
a cutting blade mounted to the drive shaft, the cutting blade having a pair of blade elements generally extending along the shaft axis, each blade element having a recess therein defining a pair of vertices adjacent the recess, the vertices dimensioned to chop the food products.

8. A blender apparatus, which comprises:
a blender jar including a base and a container for receiving food products; and
a blade mechanism at least partially disposed within the blender jar, the blade mechanism including:
a drive shaft defining a shaft axis and being engageable with a drive mechanism for rotating the drive shaft; and
a cutting blade mounted to the drive shaft, the cutting blade having a first set of diametrically opposed lobes defining opposed cutting edges and a second pair of diametrically opposed lobes defining opposed cutting edges, the lobes of the second set being arranged in oblique relation with respect to the shaft axis.

9. The blender apparatus according to claim 8 wherein the lobes of the first set are arranged in general transverse relation to the shaft axis.
